(19) United States
(12) Patent Application Publication
(10) Pub. No.: US 2003/0055684 A1
(43) Pub. Date: Mar. 20, 2003

(54) Patient relationship management

(76) Inventors: Johannes Jaskolski, Stratford, CT (US); Robert Sbriglio, Stratford, CT (US); Dilip Singh, Monroe, CT (US)

Correspondence Address: ST. ONGE STEWARD JOHNSTON & REENS, LLC, 986 BEDFORD STREET, STAMFORD, CT, 06905-5619, US

(21) Appl. No.: 09/953,824

(22) Filed: Sep. 17, 2001

(51) Int. Cl. G06F 17/60

(52) U.S. Cl. 705/3

(57) ABSTRACT

A system for providing patient care in an institutional setting is provided. The system comprises a computer; a computer network that permits communication by a plurality of participants to said computer. It further, comprises a patient information database accessible by said computer containing a plurality of data associated with a patient; a plurality of functional software modules executing on said computer for enabling a plurality of participants to manipulate said plurality of data associated with a patient; an access interface of said computer for permitting said plurality of participants access to said plurality of functional software modules; communications integration software executing on said computer for integrating a plurality of computer and communication protocols with said access interface utilized by said plurality of participants, and a rules based processing subsystem software executing on said computer for evaluating results of manipulation of said plurality of data associated with a patient by said plurality of participants through said functional modules.

### FIELD OF THE INVENTION

The invention relates to a system for managing patient care in healthcare delivery systems.

### BACKGROUND OF THE INVENTION

The healthcare delivery system in the United States is hampered by a lack of workflow integration that is especially amplified in the utilization of information technology (IT). Patient Relationship Management holds the promise of reducing cost and improving quality in healthcare provided that pertinent information and data flows effectively and securely across the healthcare delivery system, with appropriate access controls in place. However, at the present time external and internal clinical processes are fragmented and usually reside on disparate platforms and systems suited for each participant in the delivery system rather than for a comprehensive approach.

Ironically, participants in professional healthcare delivery systems, rather than using workflow management tools to effectuate savings, are burdened by ineffective IT solutions that require multiple layers of data entry and redundant processes. Lacking a common access node and storage location, the overall system begins to strain under the weight of the accumulated data as many participants create data that is never fully integrated or accessible throughout the healthcare delivery system

These issues result from the disparity of the IT needs of participants in the healthcare delivery system. A large participant, such as a hospital, has IT needs related to the functional areas, such as administration, financial, and clinical. However, these needs may have evolved over time leading to IT solutions integrated at different times and restricted to the available solutions at that time. As a result, various legacy systems may be employed. In contrast, another participant, such as a physician who practices in that hospital, may find a combination of an off-the-shelf application suite for running his practice and a handheld computing device for recording bedside visits most effective. Likely such a legacy system and application suite are not compatible. Similarly, a provider participant and an insurer may use systems that are not able to readily communicate with each other because of differing data or communication protocols. Additionally, most modern medical equipment that records and collects data electronically utilizes proprietary formats.

The lack of data flow integration seriously restricts or even prevents attempts at workflow management. Government or other regulatory organizations mandate various protocols or processes, such as for treatment or reimbursement. These protocols and processes are not automatically integrated in healthcare delivery systems. This results in three major challenges for the healthcare delivery system: scheduling of participants, collection of patient information, processing of data and functions, and complying with mandatory reporting are unnecessarily difficult. It would be unrealistic to expect every participant to accept the same standard and to follow only one medical protocol. Doing so would ignore the efficiencies created by the selection of appropriate technology and protocol.

Therefore, what is desired is a system that integrates functions and processes, utilizes open standards, integrates disparate communication protocols on a common platform, and is capable of understanding and executing workflow rules appropriate to the patient from the relevant participant interaction with the system.

### SUMMARY OF THE INVENTION

Accordingly, it is an object of the invention to manage patient care more efficiently and accurately in the healthcare delivery system.

Another object of the invention is to provide controlled access to the information related to patient relationship management.

A further object of the invention is to i make the patient relationship management functions accessible through varied communication or computer protocols.

A further object of the invention is to make the patient relationship management functions accessible over the Internet.

A further object of the invention is to provide a system of the above nature that complies with protocols established by external constraints.

These and other objects of the invention are accomplished by the provision of a system for providing patient relationship management in healthcare delivery systems.

In one embodiment the system includes a computer accessible by a plurality of participants, a communications network, a patient information database, an operational database, a suite of patient relationship management functional software modules that execute on the computer, an access interface for the participants to access the system, a rules based processing subsystem to integrate & enhance the functional software modules, and communications integration software for use in communicating with disparate communication protocols.

In another embodiment, the system further comprises a protocol database that integrates the protocols created by other participants, such as those by the Center for Medicare and Medicaid Services (CMS), previously known as Health Care Financing Administration (HCFA).

In yet a further embodiment, the system of the above embodiment is capable of having protocols added by the authorized participants.

In a different embodiment the patient consents to give his family access to follow his progress.

The invention and its particular features and advantages will become more apparent from the following detailed description considered with reference to the accompanying drawings.

### BRIEF DESCRIPTION OF THE DRAWINGS

FIG. 1 shows the overall relationship of the participants and the various functions of the system and the databases in one embodiment of the invention.

FIG. 2 illustrates an overview of the use of the system by at least one participant in the admission of a patient in accordance with this invention.

FIG. 3 illustrates in detail the intake process of a patient in accordance with this invention.

FIG. 4 illustrates in detail the administrative admissions process of a patient in accordance with this invention.

FIG. 5 illustrates in detail the clinical admissions process of a patient in accordance with this invention.

FIG. 6 illustrates the use of the financial functional software module in accordance with this invention.

FIG. 7 illustrates the performance of a clinical admissions assessment in accordance with this invention.

FIG. 8 illustrates the performance of a clinical treatment assessment in accordance with this invention.

FIG. 9 illustrates the performance of a clinical discharge assessment in accordance with this invention.

FIG. 10 illustrates one embodiment for authorizing a participant for access to the system.

FIG. 11 illustrates the use of the web access interface in accordance with the invention.

FIG. 12 illustrates the use of the rules based processing subsystem in accordance with the invention.

FIG. 13 illustrates an embodiment of the invention utilizing a protocol database and protocol functional software module

FIG. 14 illustrates in greater detail use of the system in monitoring participant satisfaction through survey.

### DETAILED DESCRIPTION OF THE DRAWINGS

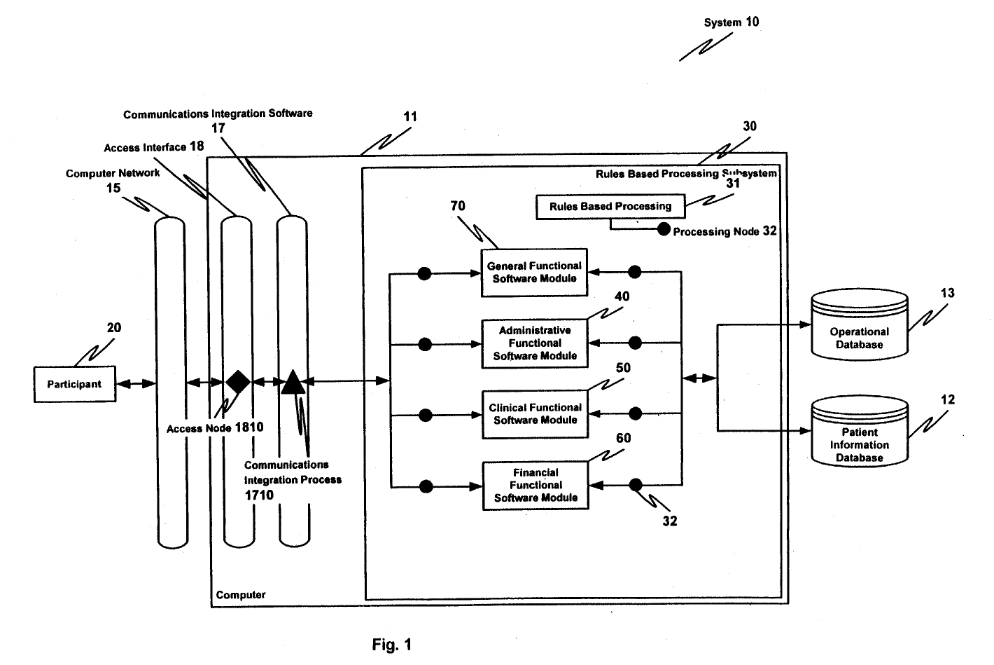

FIG. 1 depicts a system (10) for providing patient relationship management for a plurality of patients in an institution in accordance with the invention. The system (10) includes one or more participants (20) capable of using the system (10), a computer (11), a computer network (15) permitting access by a plurality of participants, one or more databases, one or more patient relationship management functional software modules (40, 50, 60, 70), and one or more software executing on the computer.

The system (10) may further include one or more communications networks linked to the computer network (15). The communications network may be a wireless voice or data network; a radio receiving, transmitting, or paging network; or a combination thereof, such as Point-to-Multipoint Wide Area Network (WAN), wireless local loop (WLL), or other network types known or to be developed.

The computer may be of any type of computing device capable of performing the functions described herein. The computer may be a personal computer, minicomputer, mainframe, supercomputer, web server, or an aggregation of computers in a distributed computer network, or a combination thereof. The computer may be physically located anywhere convenient or expeditious to the institution or as required by law, regulation, or contract.

The computer network (15) may take any suitable form that permits communication between the participants (20) and the computer, such as a local area network or wide area network. Preferably, the computer network (15) comprises the Internet; one or more Intranets; and software executing on the computer for operating at least one database, accessing the system (10) and communicating by, between, and among the participants (20) over the communications network, and implementing protocol to a plurality of patients within an institutional setting.

The databases preferably are databases that are generally known in the art and capable of storing a plurality of files. The invention also encompasses a single database, or a unique type of database, and/or multiple types of databases.

An institution, within the ambit of this invention, may be a nursing home, rehabilitation center, home health agency, an assisted living facility, an adult day care center, a hospital, a medical center, a hospice, an inpatient or outpatient drug treatment facility, or any facility associated with the care of the patient's physical, emotional, social, or mental well-being as part of the continuum of care. Institution may also be plural, that is one institution using the system (10) for more than one institutional setting. It will be readily seen by someone skilled in the art that the trend toward patient care in the patient's own home, or settings other than what may traditionally be considered a full institution makes the term “institutional setting”, within the meaning of this invention, abstract and not confined by time and space. Thus, an institutional setting may be the physical setting of the institution but it also may be external to the institution, such as the home of the patient, or within the physical setting of another institution, or it may be the combination of all of those. Further, for the purposes of this invention an institution and institutional setting may be the services a visiting nurse service performs by itself or with others in the home of the patient and where the system (10) is involved. Thus, for example, where the information from the system (10) is used, such as medical instructions for rehabilitation exercises or such as instructions to collect laboratory specimen; or protocol is initiated determined; or information is provided; or assessed, the system (10) is being used in its institutional setting.

Patient relationship management of a patient is the care of a person that is in need or who would, who will, or who has successfully or unsuccessfully derived physical, emotional, social, or mental benefit, treatment, comfort, or care from the healthcare delivery system and in accordance with the system (10) of this invention within constraints of a third party, such as a regulator or insurer. Care of the patient is the object of the patient relationship management within the healthcare delivery system.

A participant (20) in the system (10) may be the patient himself; the patient's family member or members; the patient's friends; the patient's guardian; professional, paraprofessional, skilled and unskilled staff in various capacities including medical, psychiatric, nursing; nursing aide, orderly, clinical, rehabilitative; social services, pharmacological support, case management, and any other capacity required for patient care (collectively or individually the staff); volunteers; pastoral or religious care providers; administrators; managers; researchers, customer service personnel; regulators; accrediting organizations; system (10) administrators; computer technicians; accountants, vendors; subcontractors; and others for whom authorized access to the system (10) will be beneficial. Similarly, a participant (20) in some circumstances may be a person, computer, or system (10) that is needed or beneficial for the system (10) or patient or both, such as the computer of a patient's insurer or governmental agency needed for necessary interactions such as reimbursement or regulatory matters. It will also be seen by one skilled in the art, that where one participant (20) is shown a plurality may be appropriate, such as when one practitioner is shown making an assessment, a committee may be appropriate, or a consulting colleague in direct patient contact or strictly as a professional consultant, and is included as a single participant (20).

It will be apparent to one skilled in the art, that where a person is listed as the participant (20) in many instances, one can now and likely in the future, substitute a computer or another system for the participant's (20) direct or indirect interactions. One such substitution may be video-conferencing; another may be text or voice messaging; a further may be automated medical diagnosis; yet, another may be automated inventory or inventory control or ordering.

The communication integration software (17) permits participants (20) utilizing disparate platforms to communicate with the system (10). Disparate platforms are the result of using differing architectures related to hardware and/or software standards employed on microelectronic devices. For example for computers, Digital UNIX maybe the operating system employed on a computer with an Alpha central processor, Hewlett-Packard's HP-UX on a PA-RISC central processor, IBM AIX on a PowerPC based central processing unit, Sun Microsystems' Solaris operating system on a SPARC workstation. Disparate protocols that participants (20) may use also include wireless protocols of varying types; for example: Code Division Multiple Access (CDMA), Carrier Sense Multiple Access/Collision Avoidance (CSMA/CA), Time Division Multiple Access (TDMA), Lightweight & Efficient Application Protocols (LEAP), Global System for Mobil Communications (GSM). Similarly, the disparate protocols may be related to proprietary and patented standards such as Blackberry or Wireless Application Protocol (WAP).

Preferably, the communication integration occurs through software executing on the computer (11) that receives various inputs through the computer network (15) for integrating various types of networks, such as Wireless LANs, portable computing clients, or other types of networks known or to be developed. However, the communication integration may also occur through software for interpreting data encoded utilizing an open standard such as the Extensible Mark-up Language (XML). It may also occur through hardware and/or software capable of integrating participants' (20) computing device protocols for use in accessing the system (10).

As used herein, an access interface is either hardware or software that permits participants (20) to access the system (10) from a plurality of computer and/or communications protocols. Access is the capability for the usage of system (10) as represented by the patient relationship management functional software modules of computer (11). Participants (20) are given authorized access that may include limitations or qualifications. Qualified access may not be full access, for example qualified access to the system (10) may be limited in scope and time and determined uniformly or individually.

It will be apparent to one skilled in the art that the access interface can also be a communications portal, such as a web portal, thus further permitting the disintermediation of the marketplace in favor of direct contact with the institution, such as eliminating or reducing the number of middlemen suppliers of the institution. It will be readily seen by one skilled in the relevant art that each participant (20) can be provided authorized access, or conversely denied authorized access, to any part or the entire of the system (10) according to level or levels or based on individual need or benefit. It is also readily apparent that the criteria determining, establishing, modifying, withdrawing, or disabling such authorized access can be made ahead of time, and based on one or more factors; such as participant's (20) function or system (10) need, frequency of that function or need, privacy expectations and/or rights of the patient, regulatory compliance, participant's (20) expertise. Conversely, criteria for determining, establishing, modifying, withdrawing, or disabling authorized access can be determined at the time the issue of the participant's (20) access to system (10) arises. It is equally apparent that alerting, monitoring, analysis, and/or recordation of the use, misuse, and/or abuse of the authorized access privilege may be continuous, intermittent, and/or random and include features that hinder, prevent, or deny opportunity for misuse or abuse of the authorized access privilege. Other features that secure the integrity of system (10) may also be incorporated into system (10).

It is also readily apparent that determining authorized access can range from passive authorization to full credentialing of the participant (20). In an example to illustrate passive authorization, the patient may be given an authenticator that is automatically or sufficiently contemporaneously generated upon patient's entry to the system (10) or generated upon request of the patient or by the suggestion of a participant (20). With that authenticator, for example, patient's spouse may check a plurality of patient's information, such as the latest vital statistics, laboratory reports, nursing reports, status on a treatment regimen, or other data, report, and/or results related to the patient. This access can occur via a computer or device connected to computer via the Internet, Intranet, wireless or any combination of those or via communication method or methods yet to be invented. It is readily apparent that a lesser plurality of patient's information may be provided with a different authenticator that system (10) could generate and that patient could pass on to concerned friends or family members.

The functional software modules include at least one file for implementing general functions, at least one file for implementing administrative functions, at least one file for implementing clinical functions, and at least one file implementing the financial functions of patient care. As understood by one familiar with the art, each the functional software module may be one module or separate modules able to carry out one each of the group of functions listed above. Further, as known in the art, each functional software module may be capable of routine tasks normally associated with computer systems (10) such as searching; saving, deleting, modifying files or databases; data management and interpretation tools. It will also be understood by one in the art that alternatively, the same tasks can be centralized, such as in the general functional software module (70). For clarity herewith, each module is capable to carry out the routine tasks and their specific function.

The general functional software module embodies and implements functions normally associated with a computer system (10). The general functions permit authorized participants (20) and/or the system (10) to change passwords; maintain and update the system (10); scheduling and notify of events, and other functions such as viewing of staff lists and emergency services providers; and others known in the art and/or deemed necessary or advantageous to the operation of the system (10). Preferably, the general functions may also include those functions that allow text and voice messaging, paging, voice and video conferencing, and other available or future developed communication technologies.

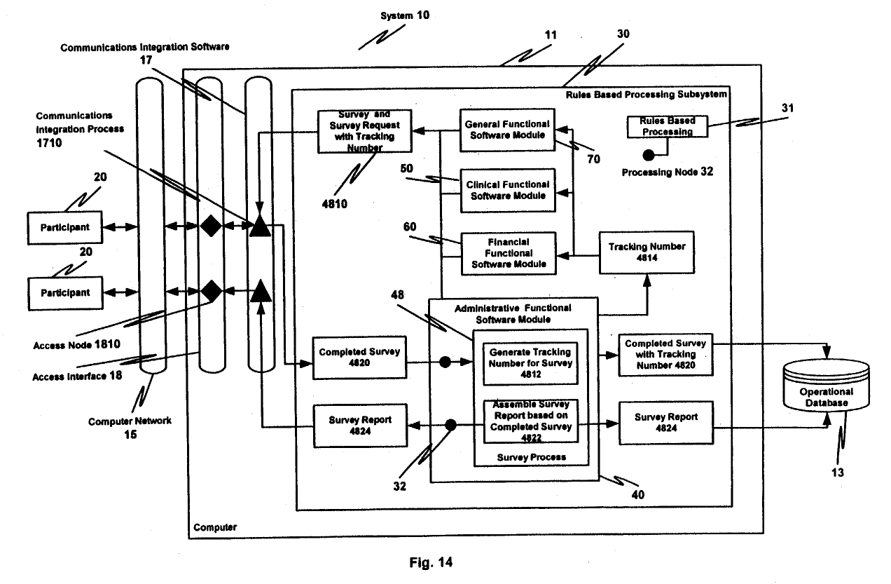

The administrative functional software module (40) embodies and implements the functions associated with the administration of an institution. Those may be patient admission and/or discharge; case number assignment; bed assignment; assignment of care providers to patient; human resources management and applications; staff employment applications; credentialing and/or privileging; patient, family, and employee satisfaction survey and analysis, as further illustrated in FIG. 14; and others deemed necessary or advantageous to the operation of the institution. These functions may be integrated as a process, processes or individualized functions. Preferably, results related to the patient, such as admission, discharge of the functions will be saved in the patient information database (12) and results not directly related to the patient are saved to an operational database (13).

The clinical functional software module (50) embodies and implements the functions that have a physical, emotional, or psychological effect or effects on the patient, such as nursing, rehabilitation therapy, dietary, social services, therapeutic recreation and others deemed necessary or advantageous to the patient. The result of the clinical functions is saved in the patient information database (12).

The financial functional software module (60) embodies and implements the financial functions related to the patient relationship management, such as payer eligibility verification, account of remittances and bills, multi payer account management, maintenance of the resident's trust account and other tasks deemed to be necessary and advantageous. Preferably, results related to the patient will be saved in the patient information database (12) and results not directly related to the patient are saved to an operational database.

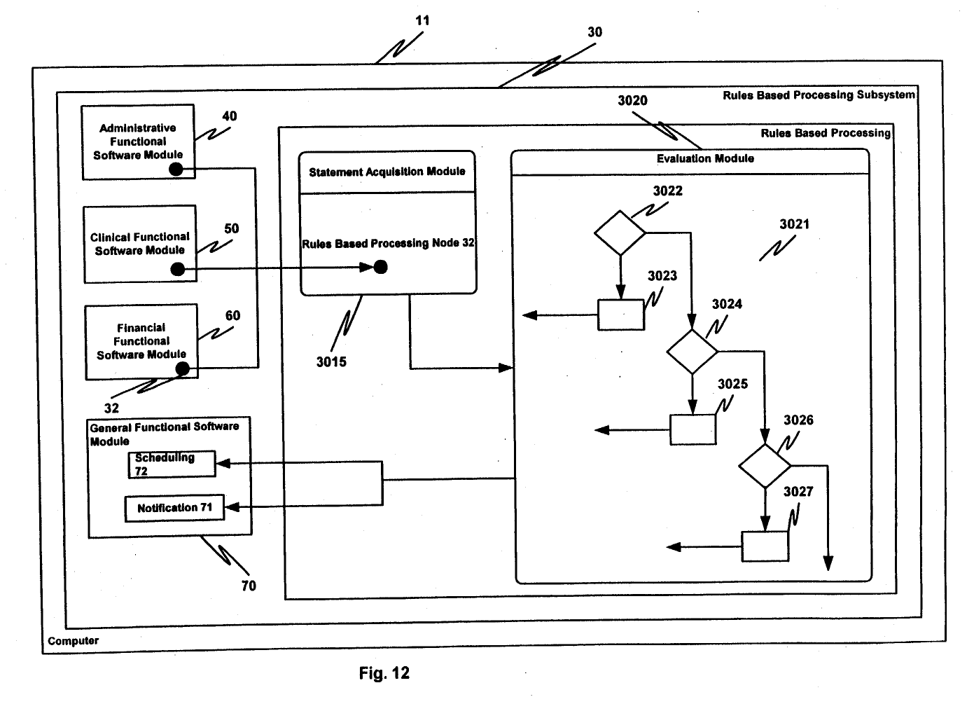

The rules based processing subsystem (30) evaluates the results from the functional software modules according to workflow rules. It determines the truth of the rules of the evaluated rule arguments. If it finds the evaluating statement to be true it initiates an action. The rule based processing subsystem (30) is shown in detail in FIG. 12.

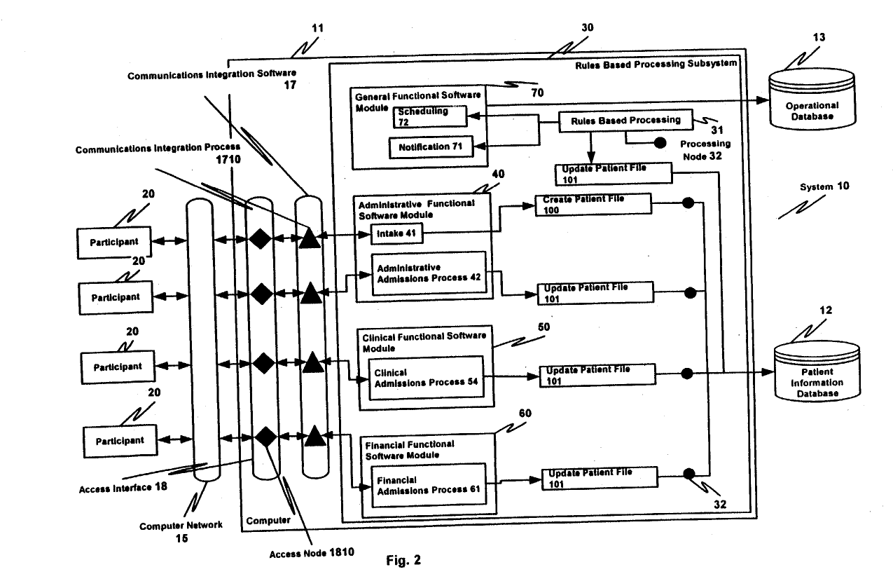

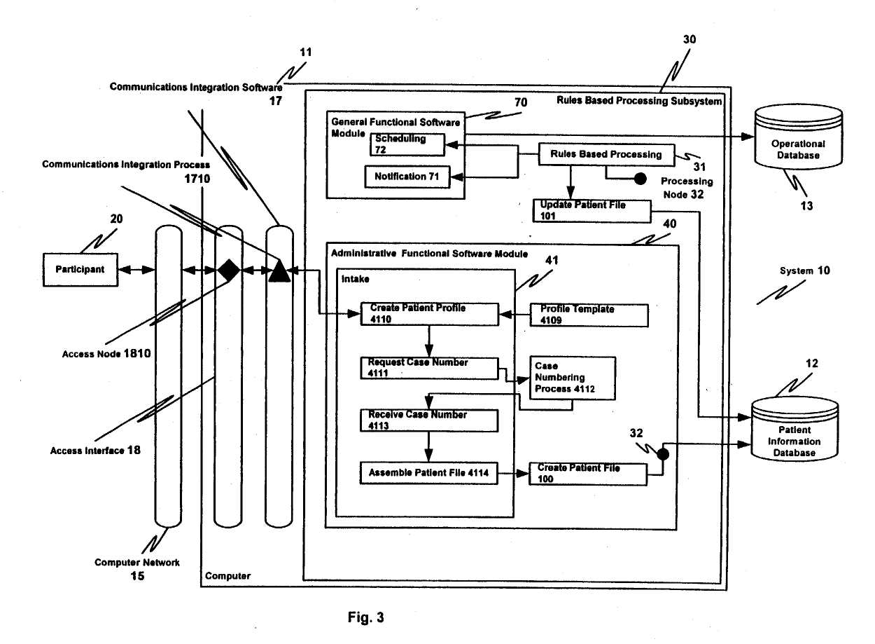

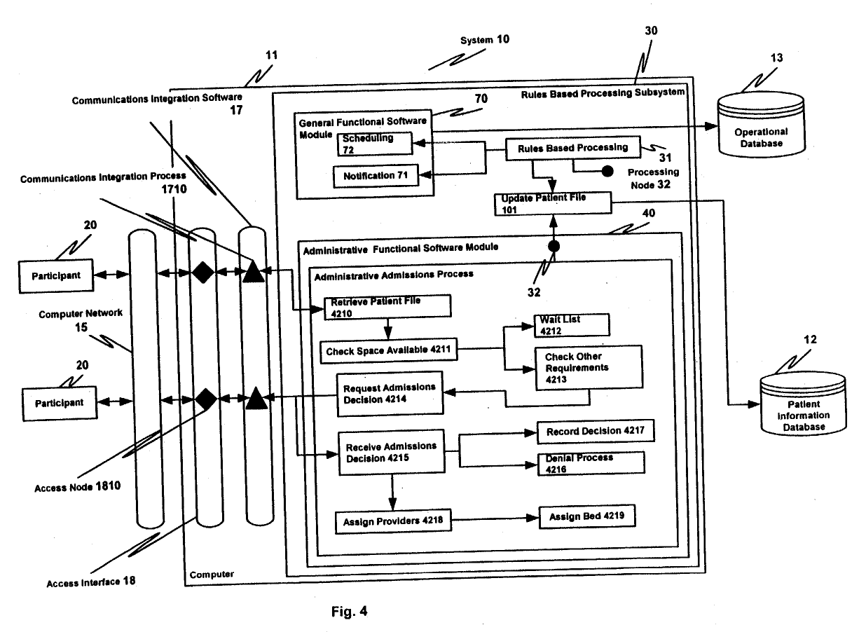

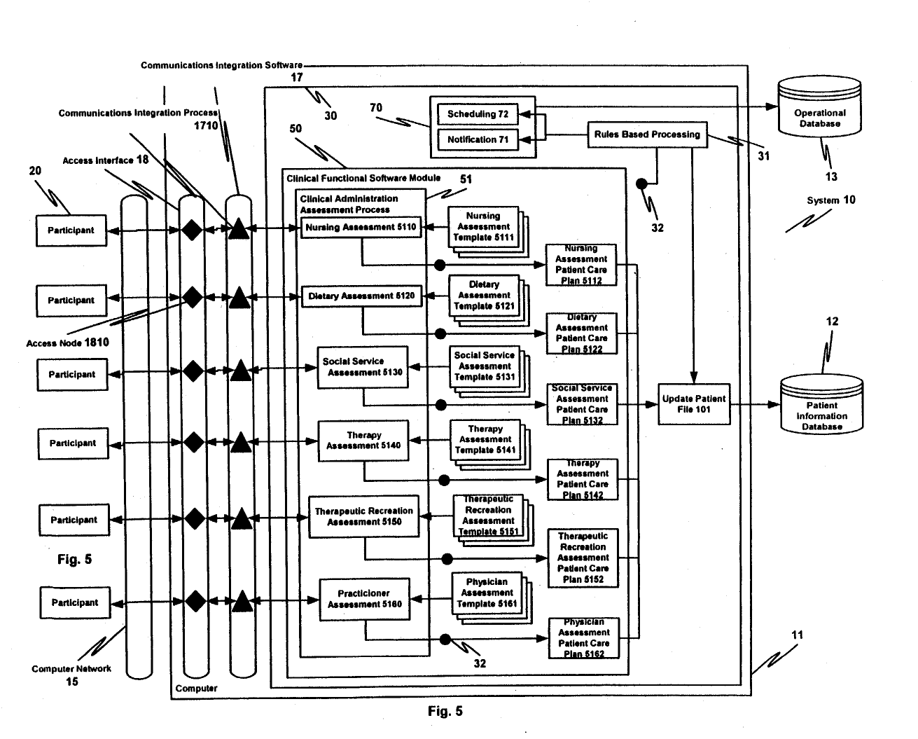

FIG. 2 illustrates an overview of the use of the system (10) by at least one participant (20) consistent with the invention in the admission of a patient. FIG. 3 shows in greater detail the intake process, FIG. 4 shows in greater detail the administrative admissions process, and FIG. 5 shows in greater detail the clinical admissions process.

As seen FIG. 3, the participant (20), such as an intake administrative aide, communicates through the computer network (15) with the computer, the communication protocol is integrated and access to the functional software modules is permitted via the access interface. A patient profile is created by that participant (20) for the patient using a template. Preferably, the template is available on the administrative functional software module (40), but other modules may be capable of supplying the template or templates in accordance with this invention.

The patient information for the patient profile may be received in hardcopy paper format, given verbally by the patient himself or by a person in a position to know, it may be received electronically, or any other method deemed appropriate or advantageous. Illustrated in FIG. 3 as an example is the integration of electronic patient information in the patient profile. Preferably and advantageous to the system (10) is the ability of the communications integration means to integrate patient information resident in one communications protocol with the communications protocol used by the participant (20) which may be in another format.

After the patient profile is created by the participant (20), the participant (20) requests that the system (10) assign a case number according to a predetermined method, such as a rule in the rule based evaluation process subsystem or stored elsewhere such as a subprocess in the operational function software module. The participant (20) receives the case number, which is also stored automatically. The participant (20) then assembles the patient file by any compatible computer process that indicates that the participant (20) has concluded his work and the system (10) then creates the patient file by storing the case number associated with the patient profile in at least one file, the patient file, in the patient information database (12). It will be readily apparent to one skilled in the art that the patient file may be one file or many files and all linked to a particular patient and that it is referable that creating and updating this and all other files be done automatically as further assumed herein.

At this juncture, using the administrative functional software module (40), the system (10) initiates the administrative admissions process of the administrative functional software module (40), which is shown in greater detail in FIG. 4 in accordance with one embodiment of the invention. Upon receipt of the patient file, the system (10) checks for space availability. If space is available, the administrative admissions process determines if other administrative concerns, such as available staffing, is an issue. If space is unavailable or predetermined criteria require it, the system (10) may wait list the patient. The system (10) may then make an admission decision on the patient directly or present the admissions data for a participant's (20) authorization for admission as shown in FIG. 4.

Upon a successful admissions decision, i.e. an institutional admission, the system (10) may assign a bed, assign a provider participant (20), such as medical practitioner or social worker, assign any number of alternate provider participants (20), or recall a patient from a wait list (4212). The system (10) also may modify the provider list upon receipt of other processes, such as the clinical assessment. It should be noted that neither bed nor space is necessarily specific to a bed that a person sleeps in, but may also be anything related patient care, such as the availability of a kidney dialysis machine, a psychiatrist's time for individual or group therapy.

At this and all succeeding steps, the rules based processing subsystem (30) evaluates the statements generated by this functional software module. Based on the truth of the statement, the subsystem selects the appropriate action, such as the notification or scheduling of clinical admissions appointments, the notification of reimbursing third parties that are mandated by the rules based processing subsystem, or other actions. Further, the subsystem saves a record of the appropriate action in the patient file.

For example in this step, the system (10) using information in the patient profile may note that based on the patient's age the patient appears eligible for Medicare and thus may create additional information requests to be filled out by the intake participant (20) or by subsequent participants (20). In another example, the system (10) may also act upon rule to notify another participant (20) that the participant's (20) patient is in the process of being admitted. This notification may be through the computer network (15), such as by e-mail, or through the communications network, such as by wireless network. As another example in this step, the system (10) using information in the patient profile may limit the provider participant (20) to only those approved by the patient's insurer.

FIG. 5 illustrates the clinical function in an admission of a patient in accordance with the invention. Upon institutional admission, the system (10) adds the admissions decision to the patient file that is made then available for other participants (20). Selected participants (20), such as the participants selected as the primary care providers, on-duty personnel, or scheduled participants are notified that a patient is being admitted and is in need of an assessment process.

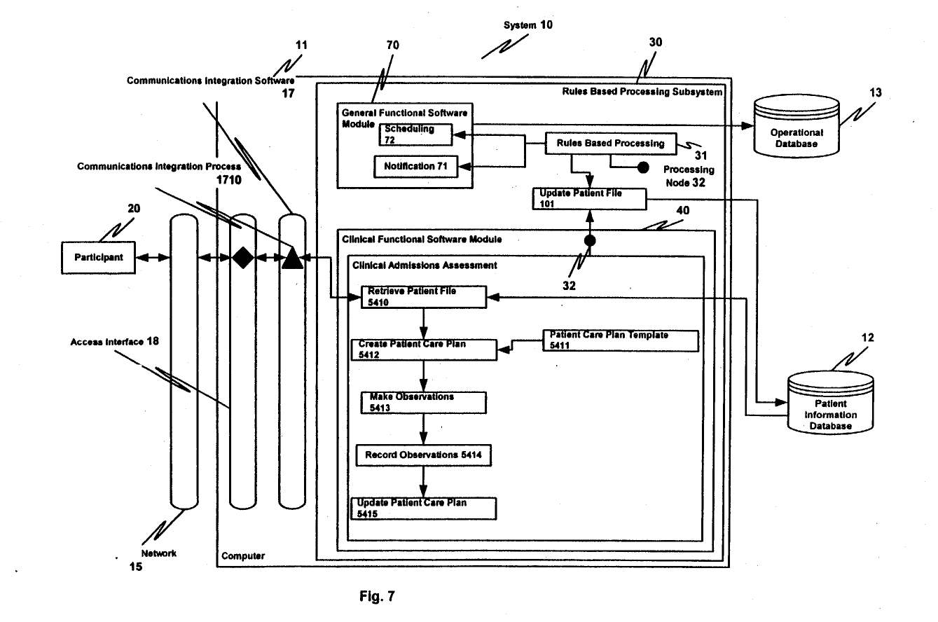

Using the clinical functional software module (50), the appropriate participants (20) perform an assessment process on the patient, as shown in FIG. 5. The participants (20), including medical and professional care practitioners, in various specialties provide their services, such as medical, nursing, dietary, social services, therapy, therapeutic recreation, and others deemed to be necessary or advantageous. Assessments may be physical assessments and/or chart based review assessment. They may be conducted in a number of disciplines such as nursing (5110), rehabilitation therapy (5120), dietary (5130), social services (5140), therapeutic recreation (5150), and others deemed necessary or advantageous to the patient in accordance. Practitioner assessments (5160) are conducted by practitioners in medical, dental, or other professional care areas. A typical clinical admissions assessment conducted by a participant, including a practitioner, is shown in detail in FIG. 7. The results are saved in the patient information database (12). Based on the assessment and professional knowledge the participants (20) create a series of patient care plans (5112, 5122, 5132, 5142, 5152, 5162) that are also saved in the patient information database (12) with the patient file. The patient care plans may also be integrated in one comprehensive patient care plan for the patient and saved in the patient information database.

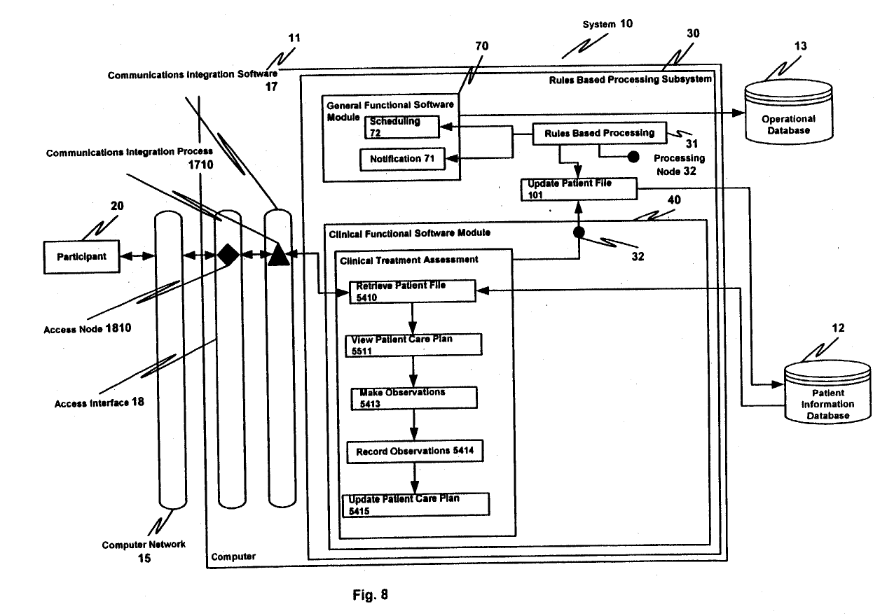

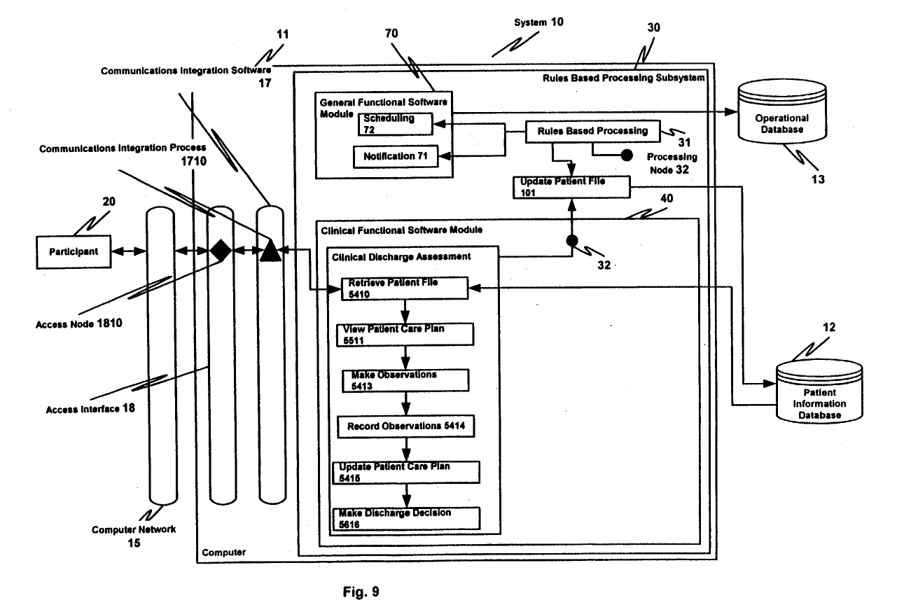

At this and all succeeding steps, the rules based processing subsystem (30) evaluates the statements generated by this functional software module. Based on the truth of the statement, the subsystem selects the appropriate action. Such appropriate action may be delayed in time such as scheduling the performance of a clinical treatment assessment or a discharge assessment as illustrated in FIGS. 8 and 9 respectively. Further, the subsystem saves a record of the appropriate action in the patient file.

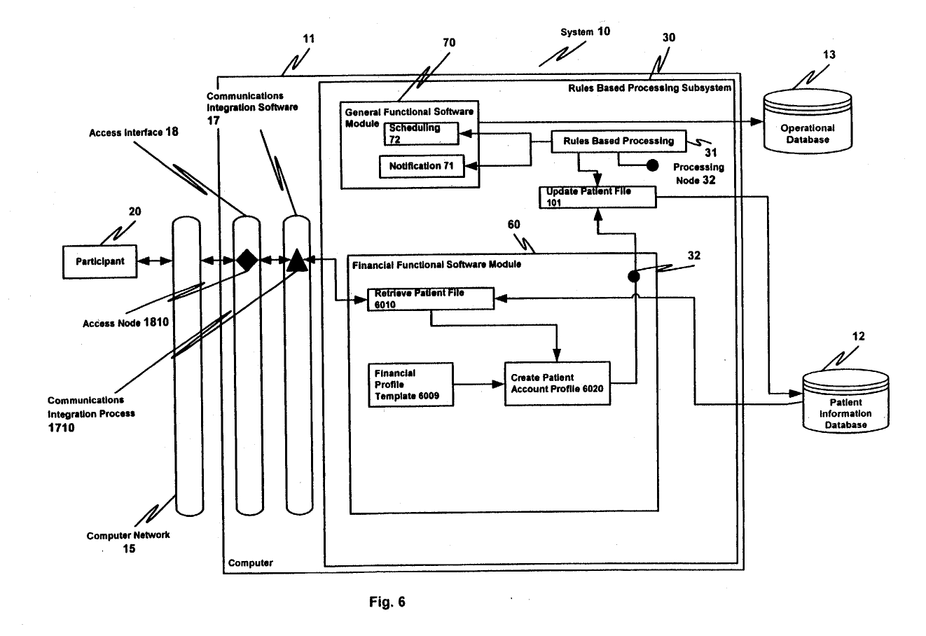

FIG. 6 illustrates the use of the financial functional software module (60). Upon institutional admission, selected participants (20), such as account trustees and case managers, are notified that a patient is being admitted. The notification message may also include any kind of statement to assure that participant (20) realizes the purpose of the message. Additionally, the participant's (20) work may have been scheduled. Using the financial functional software module (60), the participant (20) will retrieve the patient file, and create a patient account profile using financial templates and available patient information.

At this and all succeeding steps, the rules based processing subsystem (30) evaluates the statements generated by this functional software module. Based on the truth of the statement, the subsystem selects the appropriate action. Further, the subsystem saves a record of the appropriate action in the patient file.

FIG. 7 illustrates the performance of clinical admissions assessment of the patient in accordance with the system (10) of the invention. A participant (20) receives notice that an assessment is required. The notice may also contain a scheduling appointment. The participant (20), for example a physician, may visit the patient at the healthcare delivery setting. The participant (20) carries with him a wireless computing device such as a Windows CE handheld computing device and accesses the system. The participant (20) retrieves the patient file, creates a patient care plan from a template. The participant (20) makes his clinical observations, records such observations through his computing devices and saves those observations to the patient file. The participant (20) updates the care plan in accordance with his observations and saves the patient care plan to the patient file. The patient file is then updated (101) and the participant (20) can visit the next patient.

FIG. 8 illustrates a clinical treatment assessment of the patient in accordance with the system (10) of the invention. A clinical treatment assessment on the patient in accordance with patient relationship management may be conducted for any reason including medical or psychiatric follow-up or it may be scheduled according to a rule or protocol, such as to meet reimbursement requirements.

The participant (20) gains access to the system (10) and retrieves the patient file. Using the clinical functional software module (50), the participant (20) performs an assessment process on the patient. The participants (20), including medical and professional care practitioners, in various specialties provide their services, such as medical, nursing, dietary, social services, therapy, therapeutic recreation, and others deemed to be necessary or advantageous. Assessments may be physical assessments and/or chart based review assessment. They may be conducted in a number of disciplines such as nursing (5110), rehabilitation therapy (5120), dietary (5130), social services (5140), therapeutic recreation (5150), and others deemed necessary or advantageous to the patient in accordance. Practitioner assessments (5160) are conducted by practitioners in medical, dental, or other professional care areas. The results are saved in the patient information database (12). Based on the assessment and professional knowledge the participants (20) create a series of patient care plans (5112, 5122, 5132, 5142, 5152, 5162) that are also updated in the patient information database (12) with the patient file. The patient care plans may also be integrated in one comprehensive patient care plan for the patient and updated in the patient information database (12).

At this and all succeeding steps, the rules based processing subsystem (30) evaluates the statements generated by this functional software module. Based on the truth of the statement, the subsystem selects the appropriate action. Such appropriate action may be delayed in time such as scheduling the performance of an additional clinical treatment assessment or a discharge assessment as illustrated in FIG. 9. Further, the subsystem saves a record of the appropriate action in the patient file.

FIG. 9 illustrates a discharge assessment of the patient in accordance with the system (10) of the invention. A discharge assessment on the patient in accordance with patient relationship management may be conducted for any reason including medical or psychiatric follow-up or it may be scheduled according to a rule or protocol, such as to meet reimbursement requirements.

The participant (20) gains access to the system (10) and retrieves the patient file. Using the clinical functional software module (50), the participant (20) performs an assessment process on the patient. The participants (20), including medical and professional care practitioners, in various specialties provide their services, such as medical, nursing, dietary, social services, therapy, therapeutic recreation, and others deemed to be necessary or advantageous. Assessments may be physical assessments and/or chart based review assessment. They may be conducted in a number of disciplines such as nursing (5110), rehabilitation therapy (5120), dietary (5130), social services (5140), therapeutic recreation (5150), and others deemed necessary or advantageous to the patient in accordance. Practitioner assessments (5160) are conducted by practitioners in medical, dental, or other professional care areas. The results are saved in the patient information database (12). Based on the assessment and professional knowledge the participants (20) create a series of patient care plans (5112, 5122, 5132, 5142, 5152, 5162) that are also updated in the patient information database (12) with the patient file. The patient care plans may also be integrated in one comprehensive patient care plan for the patient and updated in the patient information database (12).

At this and all succeeding steps, the rules based processing subsystem (30) evaluates the statements generated by this functional software module. Based on the truth of the statement, the subsystem selects the appropriate action. Further, the subsystem saves a record of the appropriate action in the patient file.

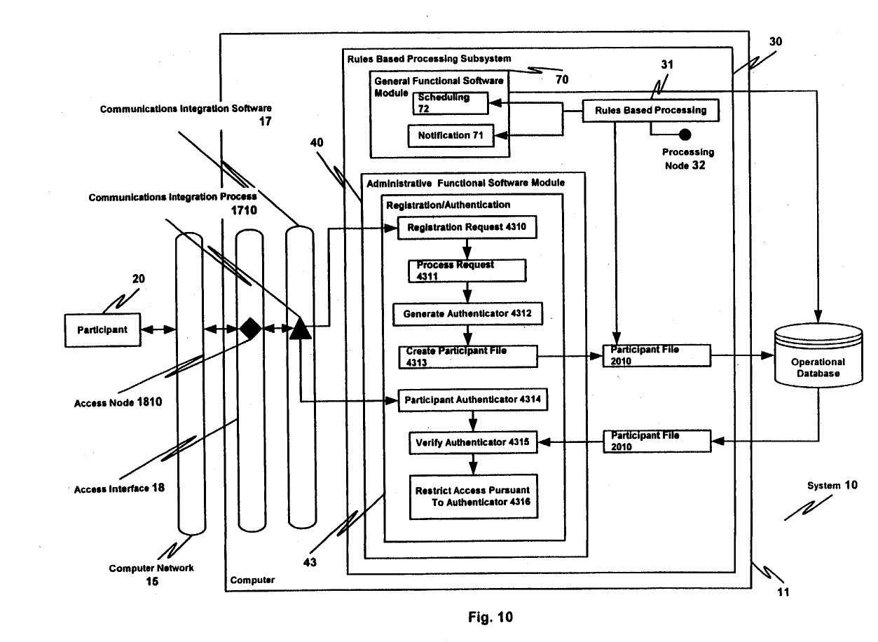

FIG. 10 illustrates one embodiment for authorization for access to the system (10). A participant (20) who needs to be credentialed, such as a treating physician, receives qualified access to the system (10). Using this access and using the system (10), the participant (20) completes the necessary credentialing request, such as a generic application, and/or specific professional, and biographic information. The request along with the information the participant (20) provided is saved in the operational database (13).

The credentialing process includes a proscribed verification process that may be attuned to the information supplied and/or level of access sought. The process for verifying the information is determined through available means and channels, such as record databases external and internal to the system (10).

If the participant (20) is approved, the participant (20) will be issued an authenticator that will grant access to the institution. Authenticators that may be employed for a participant (20) are known to be password, passcode, voice recognition, smart card technology, or biometric recognition. The appropriateness of assigning the type of authenticator can be determined according to standards understood by one skilled in the art and predetermined by the institution and/or in compliance with external constraints.

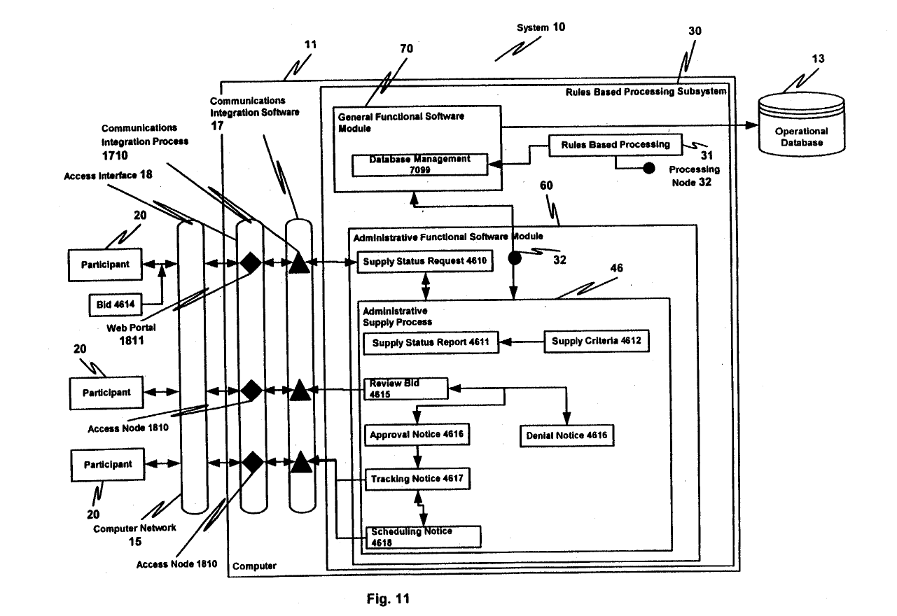

FIG. 11 shows the invention when the access interface is a web portal. One skilled in the art will realize the advantages of disintermediation to system (10). Disintermediation reduces the influence of intermediaries and permits greater efficiency in the marketplace. As applied to patient relationship management, disintermediation of the supply chain results in lower prices and enhanced choices for a participant (20) institution. Here, supplier participants (20) are granted access to the system through web portal (1811). Using an open standard, such as Extensible Markup Language (XML), available x.12 standards or any other suitable standard, supplier participants (20) are able to determine needed supplies and equipment, contact and message the participant (20) institution. A supplier participant (20), such as a pharmaceutical supplier, makes a supply status request (4610). After successfully validating this level of authorization, the administrative functional software module (40) may initiate the administrative supply process (46). Administrative supply process (46) sends the participant (20) a supply status report (4611). To do so the administrative functional software module (40) queries the data in the operational database (13) using database management functions in the general functional software module (70). Administrative supply process (46) then includes supply criteria (4612) and includes them in status report (4611). The supplier participant (20) may then issue a bid (4614) which when received is reviewed (4615) by the administrative supply process (46) and is presented to a participant (20), such as an auditor of the institution for approval. If approved approval notice (4616) is issued and tracking notice (4617) and scheduling notice (4618) are issued to other participants (20), such as supply managers. Alternatively, a denial notice (4616) may be issued to the supplier participant (20). Any of the above steps can be contemplated to be fully automated requiring no participant interaction, such as automated bidding and acceptance by a pre-qualified supplier.

However, participants (20) who access system (10) may be any type of authorized participant (20). Thus, in one embodiment, participant (20) is the patient himself. The patient may be given an authenticator that is automatically or sufficiently contemporaneously generated upon patient's entry to the system (10) or generated upon request of the patient or by the suggestion of a participant (20). With that authenticator, for example, the patient's spouse may check a plurality of patient's information, such as the latest vital statistics, laboratory reports, nursing reports, status on a treatment regimen, or other data, report, and/or results related to the patient.

FIG. 12 illustrates the use of the rules based processing subsystem (30) in accordance with the invention. Illustrated is part of an iterative search algorithm (3010) that comprises the statement acquisition module (3015) and the evaluation module (3020) of the rules based processing subsystem (30). The statement acquisition module (3015) utilizing processing node (32) acquires a statement, action, or file and passes it to the evaluation module (3020). Using the iterative loop (3021) shown, the test condition is evaluated at protocol test condition 1 (3022). If the condition is true, an action (3023) may be initiated, such as scheduling (72) or notifying (71) a participant (20). If the condition

is false, the statement is evaluated at protocol test condition 2 (3024). If that condition (3024) is true, an action (3025) of the aforementioned nature may be taken. If that condition (3024) is false, the statement is further evaluated by subsequent protocol test conditions (3026) until a true statement (3027) is encountered. Other iterative loops are known, such as those would search for several true statements.

Any predetermined action so deemed advantageous or appropriate is contemplated. Preferably, one of the actions that the rules based processing subsystem (30) can initiate is to pre-populate forms and other data reports with appropriate data. In this context pre-populate means the insertion of data relevant to the truth of the evaluated statement or resulting from application of workflow rules to the evaluated statement into an electronic or written form or report. Pre-populate may also mean the interpretation of data and insertion of data, words, or phrases that are related to other known data in relation to the evaluated statement.

As indicated above in another preferred embodiment, the rules based processing subsystem (30) accesses a messaging system (71) whereby the subsystem can notify appropriate participants (20) to take timely action when the rules indicate that such action is required. Further, the subsystem may schedule events and add that information using the event scheduling capability of the general functional software module (70). It is also preferred that when the participant (20) who was notified has not returned a response or taken action within the type of action that the system (10) recognizes that the system (10) renotify the participant (20) or that the system (10) then notifies other participants (20) according to predetermined means.

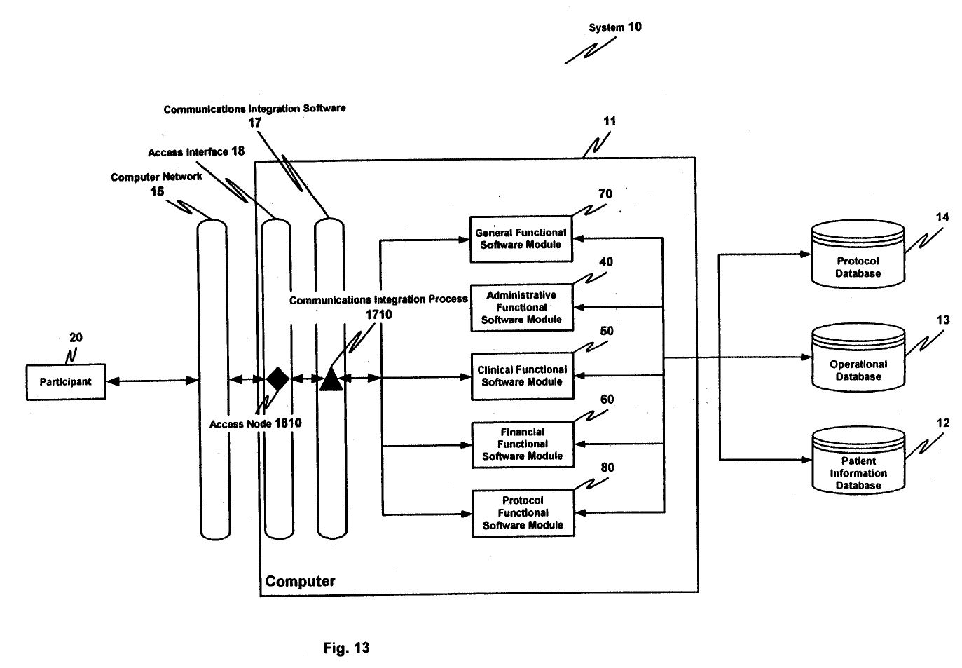

FIG. 13 illustrates an embodiment of the invention utilizing a protocol database (14) and protocol functional software module (80). The protocol functional software module (80) embodies and implements the protocols of the patient relationship management. Protocols are broad set of criteria, procedures, or initiatives such as administrative, accounting, medical, religious, social, therapeutic, and/or regulatory procedures, such as Minimum Dataset 2.0. Protocols are stored in the protocol database (14).

Protocols are used in the care of the patient, but if necessary can be deviated from, substituted for, altered, or modified according to and upon the decision of a participant (20) with the proper knowledge, skill, authority, and reason to do so. The protocols may be developed by administrators, regulators, regulatory agencies, staff, or by the treating medical personnel, individually or collectively. They may be internal to the institution or external to the institution. They may range from being specific to that patient in his or her condition to being generic to all patients in all situations. Preferably, the protocol can be selected and applied by the protocol functional software module (80) using rule-based methodology, but any method by which the system (10) can carry out and initiate the protocol is envisioned.

Further, the system saves the protocol appropriate information in the patient file. For example in this step, the system using information in the patient profile may note that based on the patient's age the patient appears eligible for Medicare and thus may create additional information requests to be filled out by the intake participant or by subsequent participants. In another example, the system may also act upon instructions from the protocol and notify another participant that the participant's (20) patient is in the process of being admitted. This notification (7110) may be through the computer network (15), such as by e-mail, or through the communications network, such as by wireless network.

FIG. 14 illustrates in greater detail use of the system in monitoring participant satisfaction through survey. The functional software modules (40, 50, 60, 70) are so enabled as to allow survey of participant (20) satisfaction at predetermined times. Predetermined times may be randomized quality assurance events; scheduled quality assurance events, such as when patient care moves from one stage to another or at discharge events, required compliance events, or other chosen any reason benefiting the system. The content of the survey may be fashioned according to the specific triggering event. Participant (20) may be the patient or a care provider or other person as described above. The surveys are assembled by system (10) into survey reports that preferably indicate problem areas and alert selected participants (20). Selected participants (20) may be institutional administrators, quality assurance officers, regulatory compliance officers, advocacy groups, professional practitioners, or anyone else who may benefit the institution or other participant from that knowledge and the system (10).

Illustrated in FIG. 14 is a typical survey process. A participant (20) using any functional software module (40, 50, 60, 70) of system (10) over the computer network (15) triggers the survey process which may be integrated on one or more functional software modules (40, 50, 60, 70), preferably on the administrative functional software module, or integrated within the rules based processing subsystem (30). The survey process generates a survey tracking number, a survey request, and a survey. Computer (11) transmits the survey request, survey, and tracking number (4810) to participant (20). A participant (20) may gain similar access and thus be similarly surveyed using a web portal access. The participant (20) reads the survey request and completes the survey. Methods to remind the participant to complete the survey and methods to require compliance with the survey request, including incentives and disincentives are known in the art and may be employed to achieve maximal compliance. System (10) receives the completed survey (4820), and the administrative functional software module using predetermined methods assembles the data into a survey report. Methods are known in the art that develop reports; such as numerical satisfaction scoring, information chaining, statistical occurrence of indicator words or functional areas, and discrepancy in data collection frequency. The completed survey report is saved to the operational database (13) and delivered to selected participants (20) for their information and ultimately to take appropriate action.

At this and all succeeding steps, the rules based processing subsystem (30) evaluates the statements generated by this functional software module. Based on the truth of the statement, the subsystem selects the appropriate action. Further, the subsystem saves a record of the appropriate action in the operational database.

Although the invention has been described with reference to a particular arrangement of parts, features, and the like, these are not intended to exhaust all possible arrangements or features, and indeed many other modifications and variations will be ascertainable to those of skill in the art.

What is claimed is:

1. A system for providing patient care in an institutional setting comprising:
a computer;
a computer network permitting communication by a plurality of participants to said computer;
a patient information database accessible by said computer containing a plurality of data associated with a patient;
a plurality of functional software modules executing on said computer for enabling a plurality of participants to manipulate said plurality of data associated with a patient;
an access interface of said computer for permitting said plurality of participants access to said plurality of functional software modules;
communications integration software executing on said computer for integrating a plurality of computer and communication protocols with said access interface utilized by said plurality of participants, and
a rules based processing subsystem software executing on said computer for evaluating results of manipulation of said plurality of data associated with a patient by said plurality of participants through said functional modules.

2. The system of claim 1 wherein said plurality of functional software modules comprises software executing on said computer for
receiving a patient profile submitted by a participant over said computer network,
generating a case number for said patient profile,
assembling and creating a patient file on said patient database, said patient file including said patient profile and associated with said case number,
requesting and receiving an admissions decision by an participant, and
saving said admission decision of the patient to said patient file on said patient database with said patient profile and associated with said case number.

3. The system of claim 2 wherein said plurality of functional software modules comprises software executing on said computer for
retrieving said patient file from said patient database with said patient profile and associated with said case number by a participant;
presenting said patient file to the participant,
receiving a clinical assessment of a patient submitted to said computer by the participant over said computer network;
saving said clinical assessment to said patient file on said patient database with said patient profile and associated with said case number;
creating a patient care plan by a participant based on said clinical assessment; and
saving said patient care plan to said patient file on said patient database with said patient profile and associated with said case number by a participant.

4. The system of claim 3 wherein said plurality of functional software modules comprises software executing on said computer for
retrieving said patient file from said patient database with said patient profile and associated with said case number by a participant;
presenting said patient file to the participant,
receiving a clinical assessment of a patient submitted to said computer by the participant over said computer network;
creating a patient care plan by a participant;
saving said care plan to said patient file on said patient database with said patient profile and associated with said case number by a participant;
creating an event schedule related to the patient by a participant; and
saving said event schedule related to the patient to said patient file on said patient database with said patient profile and associated with said case number by a participant.

5. The system of claim 4 wherein said plurality of functional software modules comprises software executing on said computer for
indicating a discharge of the patient by a participant;
creating a record of the discharge of the patient by a participant; and
saving said record of the discharge of the patient to said patient file on said patient database with said patient profile and associated with said case number by a participant.

6. The system of claim 2 wherein said plurality of functional software modules comprises software executing on said computer for
retrieving said patient file from said patient database with said patient profile and associated with said case number by a participant;
presenting said patient file to the participant,
making a financial assessment of a patient by a participant;
saving said financial assessment to said file on said patient database with said patient profile and associated with said case number;
creating a financial profile by a participant; and
saving said financial profile to said file on said patient database with said patient profile and associated with said case number by a participant.

7. The system of claim 1 wherein said system further comprises
an operational database accessible by said computer containing a plurality of data associated with the institution;
a plurality of functional software modules executing on said computer for enabling a plurality of participants to manipulate said plurality of data associated with the institution.

8. The system of claim 1 wherein said plurality of functional software modules comprises software executing on said computer for
creating a participant profile by a requesting participant;
authenticating the requesting participant;
authorizing the requesting participant by the system; and
giving the requesting participant access to the system.

9. The system of claim 1 said access interface of said computer for accessing said plurality of functional software modules by said plurality of participants further comprises
a communications portal for use by a plurality of participants through an internet connection.

10. The system of claim 1 wherein said system further comprises a communications system for accessing a wireless network.

11. The system of claim 1 wherein said rules based processing subsystem software further comprises software executing on said computer for notifying a plurality of participants according to the results said manipulation of said plurality of data associated with a patient.

12. The system of claim 1 wherein said rules based processing subsystem software further comprises software executing on said computer for scheduling events according to the results of said manipulation of said plurality of data associated with a patient.

13. The system of claim 7 wherein said rules based processing subsystem software further comprises software executing on said computer for evaluating results of manipulation of said a plurality of data associated with the institution by said plurality of participants.

14. The system of claim 1 wherein said rules based processing subsystem software further comprises software executing on said computer for motifying a plurality of participants according to the results of said manipulation of said plurality of data associated with the institution.

15. The system of claim 12 wherein said rules based processing subsystem software further comprises software executing on said computer for scheduling events according to the results of said manipulation of said plurality of data associated with the institution.

16. The system of claim 7 wherein said plurality of functional software modules comprises software executing on said computer for
creating a survey and survey request, and
transmitting said survey request and survey to said participant over said computer network.

17. The system of claim 16 wherein said plurality of functional software modules further comprises software executing on said computer for
generating a tracking number for said survey,
saving said tracking number to said survey,
receiving from participant a completed survey over a computer network,
saving said completed survey with said tracking number on said operational database,
assembling said completed survey associated with said tracking number into a survey report,
saving said survey report to said operational database, and
delivering to selected participants said survey report.

18. The system of claim 16 wherein said rules based processing subsystem further comprises software executing on said computer for
generating a tracking number for said survey,
saving said tracking number to said survey,
receiving from participant a completed survey over a computer network,
saving said completed survey with said tracking number on said operational database,
assembling said completed survey associated with said tracking number into a survey report,
saving said survey report to said operational database, and
delivering to selected participants said survey report.

19. A system for providing patient care in an institutionalized setting comprising:
a computer;
a computer network permitting communication between a plurality of participants and said computer;
a patient information database accessible by said computer containing a plurality of patient files, each of said patient files containing a plurality of data associated with a particular patient;
assessment data related to a patient submitted to said computer by a participant over said computer network;
a clinical functional software module executing on said computer for facilitating assessment data entry over said computer network from said participant;
a financial functional software module executing on said computer for providing financial management of services provided to the patient by the institutionalized setting;
a general functional software module executing on said computer for facilitating a plurality of general functions of the institutionalized setting; and,
a rules based processing subsystem executing on said computer for evaluating results from said functional software modules according to predetermined workflow rules, said subsystem comprising software for receiving assessment data submitted by said participant through said clinical functional software module, evaluating said submitted data against said predetermined workflow rules, updating a patient file to reflect said assessment data and directing said submitted data to one or more of said functional software modules based on said evaluation;
wherein said clinical functional software module comprises software for interacting with said participant, receiving said assessment data from said participant, and directing said assessment data to said rules-based processing subsystem; said financial functional software module comprises software for receiving said assessment data from said rules-based subsystem, determining fees associated with said assessment data, and updating said patient file to reflect said determined fees; and said general functional software module comprises software for receiving said assessment data from said rules-based processing subsystem, determining appointments associated with said assessment data, scheduling said determined appointments, updating said patient profile to reflect said determined appointments, and notifying at least one of said plurality of participants of said determined appointments.

20. The system of claim 19 wherein said plurality of functional software modules comprises software executing on said computer for
receiving a patient profile submitted by a participant over said computer network,
generating a case number for said patient profile,
assembling and creating a patient file on said patient database, said patient file including said patient profile and associated with said case number,
requesting and receiving an admissions decision by an participant, and
saving said admission decision of the patient to said patient file on said patient database with said patient profile and associated with said case number.

21. The system of claim 20 wherein said plurality of functional software modules comprises software executing on said computer for
retrieving said patient file from said patient database with said patient profile and associated with said case number by a participant;
presenting said patient file to the participant,
receiving a clinical assessment of a patient submitted to said computer by the participant over said computer network;
saving said clinical assessment to said patient file on said patient database with said patient profile and associated with said case number;
creating a patient care plan by a participant based on said clinical assessment; and
saving said patient care plan to said patient file on said patient database with said patient profile and associated with said case number by a participant.

22. A system for providing patient care in an institutional setting comprising:
a computer;
a computer network permitting communication by a plurality of participants to said computer;
a patient information database accessible by said computer containing a plurality of data associated with a patient;
a plurality of functional software modules executing on said computer for enabling a plurality of participants to manipulate said plurality of data associated with a patient computer and for evaluating results of manipulation of said plurality of data associated with a patient by said plurality of participants through said functional modules;
an access interface of said computer for permitting said plurality of participants access to said plurality of functional software modules; and
communications integration software executing on said computer for integrating a plurality of computer and communication protocols with said access interface utilized by said plurality of participants.

23. The system of claim 22 wherein said plurality of functional software modules comprises software executing on said computer for
creating a survey and survey request, and
transmitting said survey request and survey to said participant over said computer network.

24. The system of claim 23 wherein said administrative functional software modules comprises software executing on said computer for
generating a tracking number for said survey,
saving said tracking number to said survey,
receiving from participant a completed survey over a computer network,
saving said completed survey with said tracking number on said operational database,
assembling said completed survey associated with said tracking number into a survey report,
saving said survey report to said operational database, and
delivering to selected participants said survey report.

25. The system of claim 23 wherein said administrative functional software modules comprises software executing on said computer for
generating a tracking number for said survey,
saving said tracking number to said survey,
receiving from participant a completed survey over a computer network,
saving said completed survey with said tracking number on said operational database,
assembling said completed survey associated with said tracking number into a survey report,
saving said survey report to said operational database, and
delivering to selected participants said survey report.
